(19) United States
(12) Patent Application Publication
(10) Pub. No.: US 2024/0289652 A1
(43) Pub. Date: Aug. 29, 2024

(54) DEVICE AND METHOD FOR GENERATION OF DIVERSE QUESTION-ANSWER PAIR

(71) Applicant: KOREA UNIVERSITY RESEARCH AND BUSINESS FOUNDATION, Seoul (KR)

(72) Inventors: Heuiseok LIM, Seoul (KR); Sugyeong EO, Seoul (KR); Hyeonseok MOON, Seoul (KR); Jinsung KIM, Seoul (KR); Yoona HUR, Seoul (KR); Jeongwook KIM, Seoul (KR)

(21) Appl. No.: 18/585,166

(22) Filed: Feb. 23, 2024

(30) Foreign Application Priority Data
Feb. 23, 2023 (KR) 10-2023-0024355
Jan. 22, 2024 (KR) 10-2024-0009742

(51) Int. Cl. G06N 5/04

(52) U.S. Cl. CPC G06N 5/04

(57) ABSTRACT

Disclosed is a device and method for educational question-answer pair generation (QAG) considering type diversity. The method for question-answer pair generation is performed by a computing device and includes generating a query-focused summarization (QFS) for a passage; generating an initial answer based on the passage and the QFS; generating a question corresponding to the initial answer based on the initial answer, the passage, and an interrogative word; generating an answer corresponding to the question based on the question and the passage and generating a question-answer (QA) pair; and deriving a final QA pair by selecting at least one QA pair from among the QA pairs.

### CROSS-REFERENCE TO RELATED APPLICATION

The present application claims the benefit of priority to Korean Patent Application No. 10-2023-0024355, filed on Feb. 23, 2023, and Korean Patent Application No. 10-2024-0009742, filed on Jan. 22, 2024, in the Korean Intellectual Property Office.

All of the aforementioned applications are hereby incorporated by reference in their entireties.

### TECHNICAL FIELD

The present invention relates to natural language processing (NLP) among artificial intelligence techniques, and more particularly, to a device and method for generating a question-answer (QA) pair for a given passage.

### RELATED ART

Recent advances in the field of question-answer pair generation (QAG) have raised interest in applying this technique to the educational field. However, the diversity of question-answer (QA) types remains challenge despite its contribution to comprehensive learning and assessment of children. The present invention proposes a QAG framework that enhances QA type diversity by generating various interrogative sentences and implicit and/or explicit answers. The proposed framework includes a query-focused summarization (QFS)-based answer generator, an iterative QA generator, and a relevancy-aware ranker.

The two generators (answer generator and QA generator) aim to expand the number of candidates while covering various types. The ranker trained based on in-context negative samples clarifies top-N outputs based on the ranking score. Evaluations and detailed analyses demonstrate that the proposed approach outperforms previous state-of-the-art results by significant margins, achieving improved diversity and quality. Proposed task-oriented processes are consistent with real-world demand, which highlights high applicability of a system proposed herein.

### DESCRIPTION

### Subject

The technical subject to be achieved by the present invention is to provide a device and method for generating a question-answer (QA) pair in consideration of type diversity.

### Solution

A method for question-answer generation pair according to an example embodiment relates to a method for question-answer pair generation performed by a computing device and includes generating a query-focused summarization (QFS) for a passage; generating an initial answer based on the passage and the QFS; generating a question corresponding to the initial answer based on the initial answer, the passage, and an interrogative word; generating an answer corresponding to the question based on the question and the passage and generating a question-answer (QA) pair; and deriving a final QA pair by selecting at least one QA pair from among the QA pairs.

### Effect

According to example embodiments of the present invention, a method of generating as various types of question-answer (QA) pairs as possible and adopting only a QA pair predicted to have excellent quality as final results among them is employed. Also, through this, it is possible to improve the quality of question-answer pair generation (QAG) in the existing QAG research and, at the same time, to greatly increase QA type diversity.

### BRIEF DESCRIPTION OF DRAWINGS

Detailed description related to each drawing is provided to further sufficiently understand drawings cited in the detailed description of the present invention.

FIG. 1 illustrates the overall architecture of a question-answer pair generation (QAG) framework proposed in the present invention.

FIG. 2 is a flowchart illustrating a method for question-answer pair generation according to an example embodiment of the present invention.

### MODE

Disclosed hereinafter are exemplary embodiments of the present invention. Particular structural or functional descriptions provided for the embodiments hereafter are intended merely to describe embodiments according to the concept of the present invention. The embodiments are not limited as to a particular embodiment.

Various modifications and/or alterations may be made to the disclosure and the disclosure may include various example embodiments. Therefore, some example embodiments are illustrated as examples in the drawings and described in detailed description. However, they are merely intended for the purpose of describing the example embodiments described herein and may be implemented in various forms. Therefore, the example embodiments are not construed as limited to the disclosure and should be understood to include all changes, equivalents, and replacements within the idea and the technical scope of the disclosure.

Terms such as “first” and “second” may be used to describe various parts or elements, but the parts or elements should not be limited by the terms. The terms may be used to distinguish one element from another element. For instance, a first element may be designated as a second element, and vice versa, while not departing from the extent of rights according to the concepts of the present invention.

Unless otherwise clearly stated, when one element is described, for example, as being “connected” or “coupled” to another element, the elements should be construed as being directly or indirectly linked (i.e., there may be an intermediate element between the elements). Similar interpretation should apply to such relational terms as “between”, “neighboring,” and “adjacent to.”

Terms used herein are used to describe a particular exemplary embodiment and should not be intended to limit the present invention. Unless otherwise clearly stated, a singular term denotes and includes a plurality. Terms such as “including” and “having” also should not limit the present invention to the features, numbers, steps, operations, subparts and elements, and combinations thereof, as described; others may exist, be added or modified. Existence and addition as to one or more of features, numbers, steps, etc. should not be precluded.

Unless otherwise clearly stated, all of the terms used herein, including scientific or technical terms, have meanings which are ordinarily understood by a person skilled in the art. Terms, which are found and defined in an ordinary dictionary, should be interpreted in accordance with their usage in the art. Unless otherwise clearly defined herein, the terms are not interpreted in an ideal or overly formal manner.

Example embodiments of the present invention are described with reference to the accompanying drawings. However, the scope of the claims is not limited to or restricted by the example embodiments. Like reference numerals proposed in the respective drawings refer to like elements.

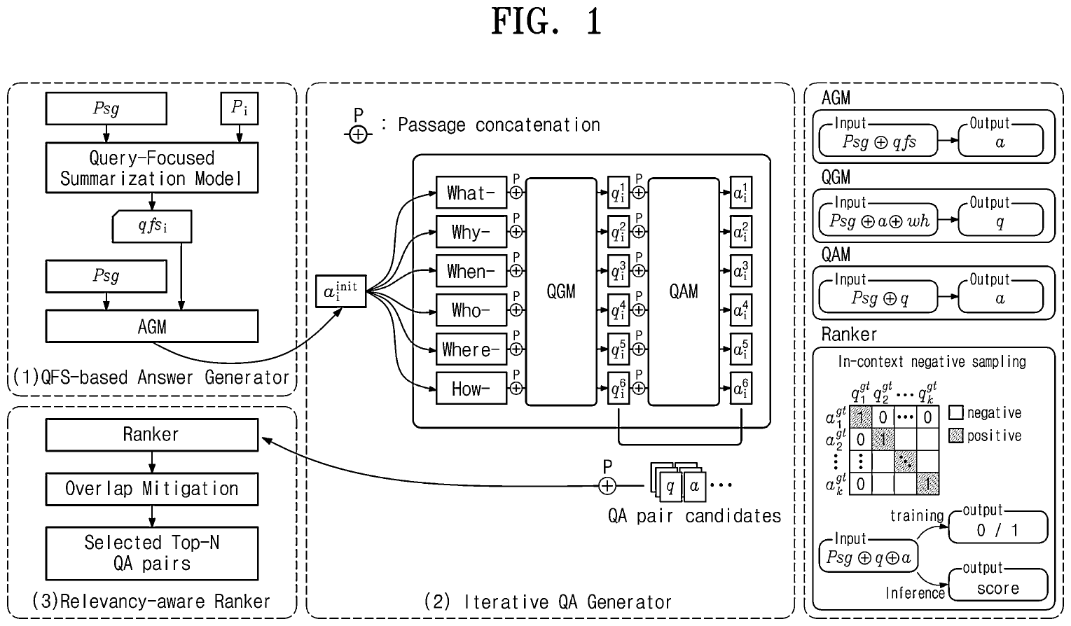

A question-answer pair generation (QAG) framework proposed herein includes three task-oriented processes, that is, a query-focused summarization (QFS)-based answer generator, an iterative question-answer (QA) generator, and a relevancy-aware ranker. The main goal of the two generators (answer generator and QA generator) is to expand QA pair candidates that include diverse question and answer types. The ranker aims to determine the final output by scoring QA pair candidates. The overall QAG architecture of the proposed framework is illustrated in FIG. 1.

### QFS-Based Answer Generator

In an initial answer generation process, query-focused summarization (QFS) is employed to capture salient information related to a given sentence. A QFS model generates a query-focused summary of a given passage by referring to a relevant key. The query-focused summarization (QFS)-based answer generator proposed herein may employ a query-focused summary generation model (or query-focused summary generation technique), such as Vig et al., (Jesse Vig, Alexander Fabbri, Wojciech Kryscinski, Chien-Sheng Wu, and Wenhao Liu. 2022. Exploring neural models for query-focused summarization. In Findings of the Association for Computational Linguistics: NAACL 2022, pages 1455-1468, Seattle, United States. Association for Computational Linguistics.). Also, detailed description related thereto may be referred to the above paper. Then, a generated summary is input to a generative answer generation model (AGM) to output implicit and/or explicit answers.

Let Psg denote a passage that includes n sentences, p₁, . . . , pₙ, and a corresponding ground-truth (GT) QA pair be

$$( {Q}^{gt} , {A}^{gt} ) = {\{ ( {q}_{j}^{gt} , {a}_{j}^{gt} ) \}}_{j = 1}^{m} .$$

Initially, a query focused summary

$${qfs}_{j}^{gt} = QFS ( Psg , {q}_{j}^{gt} )$$

of Psg is generated using a pretrained QFS model (QFS). Then, the AGM termed as θ_{AGM} is trained with concatenated input of Psg and gfsⱼ^{gt} in a sequence-to-sequence manner. A loss function for each Psg is estimated as shown in Equation 1.

$${L}_{AGM} = - {\sum }_{( {q}_{j}^{gt} , {a}_{j}^{gt} ) ∈ ( {Q}^{gt} , {A}^{gt} )} {E}_{{θ}_{AGM}} ( {a}_{j}^{gt} \vert Psg , {qfs}_{j}^{gt} ) \qquad [ Equation 1 ]$$

In an inference phase, for each sentence pᵢ in Psg, qfsᵢ=QFS(Psg, pᵢ) is generated. Then, the AGM produces a single initial answer aᵢ^{init} for corresponding qfsᵢ. A resulting answer set A^{init} has n answers since answers are generated for every sentence in the passage. A^{init} is expressed as Equation 2.

$${A}^{init} = \{ {θ}_{AGM} ( Psg , {qfs}_{i} ) \vert {p}_{i} ∈ Psg \} \qquad [ Equation 2 ]$$

### Iterative QA Generator

After the initial answer set A^{init} is generated, a next step is to expand QA pair candidates to reflect question type diversity. To achieve this, proposed are an interrogative word-indicated question generation model (QGM), denoted by θ_{QGM}, and a generative question-answering model (QAM), denoted by θ_{QAM}. The QGM and the QAM are sequentially executed based on the initial answer to generate a set of QA pair candidates. The following describes education and inference processes of each model.

Interrogative word-indicated QGM: The QGM is trained with a GT QA pair set to generate questions by referring to answers and their corresponding passages. Including interrogative words in a training phase allows controllable question generation to follow a desired interrogative type during inference.

The interrogative word of each qⱼ^{gt} in the GT QA pair set is denoted as whⱼ^{gt}. In setting, wh is an element of interrogative word set WH={Who, When, What, Where, Why, How}. θ_{QGM} is trained to generate question qⱼ^{gt} by inputting the concatenated input of Psg, aⱼ^{gt}, and whⱼ^{gt}. Training is performed in a sequence-to-sequence manner and is optimized using a loss function of Equation 3.

$${L}_{QGM} = - {\sum }_{( {q}_{j}^{gt} , {a}_{j}^{gt} ) ∈ ( {Q}^{gt} , {A}^{gt} )} {E}_{{θ}_{QGM}} ( {q}_{j}^{gt} \vert Psg , {a}_{j}^{gt} , {wh}_{j}^{gt} ) \qquad [ Equation 3 ]$$

In an inference phase, diversity is prioritized and questions are generated by considering each interrogative word in WH as an indicator. For each aᵢ^{init} ∈A^{init} generated in a first step and its corresponding passage Psg, θ_{QGM} configures a QA pair set QA¹, which may be expressed as Equation 4.

$${QA}^{1} = \{ ( {θ}_{QGM} ( Psg , {a}_{i}^{init} , wh ) , {a}_{i}^{init} ) \vert wh ∈ WH , {a}_{i}^{init} ∈ {A}^{init} \} \qquad [ Equation 4 ]$$

In this way, QA pair candidates with high relevance to the passage may be generated. This process encourages expansion of question types, but not all questions generated are related to initial answers.

Answer Adjustment: To consider relevance between QA pairs, answers are reconstructed through θ_{QAM} trained with a set of GT QA pairs. This process helps avoid linking inappropriate questions to a given initial answer, such as asking a “How” question for an answer aimed at a specific person. Training of θ_{QAM} is proceeded by optimizing a loss function of Equation 5.

$${L}_{QAM} = - {\sum }_{( {q}_{j}^{gt} , {a}_{j}^{gt} ) ∈ ( {Q}^{gt} , {A}^{gt} )} {E}_{{θ}_{QAM}} ( {a}_{j}^{gt} \vert Psg , {q}_{j}^{gt} ) \qquad [ Equation 5 ]$$

In a subsequent inference phase, answers to all questions in QA¹ are adjusted through θ_{QAM}. That is, a reconstructed QA pair set, denoted by QA², is expressed as Equation 6.

$${QA}^{2} = \{ ( {q}_{i}^{j} , {θ}_{QAM} ( Psg , {q}_{i}^{j} ) ) \vert ( {q}_{i}^{j} , {a}_{i}^{init} ) ∈ {QA}^{1} \} \qquad [ Equation 6 ]$$

Here, QA² denotes a final QA pair candidate set in which relevance between pairs is supervised through QAM while maintaining the diversity of question types.

### Relevancy-Aware Ranker

With the relevancy-aware ranker (or relevancy-aware ranking model), top-N ranked QA pairs that exhibit high relevance between passages and QA pairs may be selected.

The ranking model denoted by θ_{Rank} produces the relevance score for each QA pair. To train the ranking model θ_{Rank}, a contrastive training dataset may be composed by collecting in-context negative samples in the GT QA pair set. In training data, GT QA pairs are considered as positive samples and other QA pairs in the same passage are considered as negative samples. In detail, the negative samples may be generated by replacing answers with other answers in passage while maintaining the passage and questions or by replacing questions with other questions in the passage while maintaining the passage and the answers.

For a given passage P_{sg} and a corresponding GT QA pair set (Q^{gt}, A^{gt}), positive sample set

$$POS = \{ ( {q}_{i}^{gt} , {a}_{j}^{gt} ) \vert {q}_{i}^{gt} ∈ {Q}^{gt} , {a}_{j}^{gt} ∈ {A}^{gt} , i = j \}$$

and negative sample set

$$NEG = \{ ( {q}_{i}^{gt} , {a}_{j}^{gt} ) \vert {q}_{i}^{gt} ∈ {Q}^{gt} , {a}_{j}^{gt} ∈ {A}^{gt} , i \neq j \}$$

may be constructed. According to an example embodiment, QA pairs in other passages are considered as easy negative cases, which may not be included as negative samples in ranker training.

Then, QA pairs and their corresponding passages are concatenated to construct input sequences for training θ_{Rank}. By feeding this input sequence, θ_{Rank} is trained to classify binary labels representing negative and positive.

In the inference phase, θ_{Rank} returns scores of the input QA pair to be classified as positive and negative, respectively. Each QA pair may be ranked by referring to both scores.

In more detail, the ranker is trained to perform binary classification between positive samples and negative samples at 1/0 (or 0/1). During inference, previously generated QA pairs are fed as input to the ranker along with their corresponding passages and the ranker may extract a value corresponding to a CLS token in a last hidden state just before outputting 1/0, may pass softmax, and may output a prediction value to be predicted for each label. After listing the same in order of likelihood of being predicted to be 1 (or 0), overlap removal (or overlap mitigation) may be performed.

This this process, the ranker is trained to prioritize a selection of data that exhibits high correlation between QA pairs and high relevance to the corresponding passages.

Overlap Mitigation: While the ranker model enhances the relevance of QA pairs, an issue of duplication is present in which top-ranked QA pairs constitute similar forms. To alleviate this issue, a re-scaled ranking score is computed to reduce lexical overlap of answers in QA pair candidates

QA pairs are sequentially selected in order of high scores computed using the ranking model. To consider the lexical overlap in each selection process, the Rouge-L score between a selecting pair and previously selected QA pairs is measured. The score s of each pair measured by the ranking model is re-scaled as s-Rouge-L*abs(s). Through this process, scores of QA pairs that exhibit high lexical overlap with the previously selected QA pairs are down-scaled. This allows a selection of various types of QA while reflecting the scores computed by the ranking model. A detailed procedure of an overlap mitigation algorithm is presented in Algorithm 1.

As a specific example, Rougue-L scores between a top-ranked QA pair (t1) and remaining QA pairs are measured. Then, a QA pair having a highest value based on the re-scaled score is selected as a second-place QA pair (t2). For t1 and t2, Rougue-L scores with remaining QA pairs excluding t1 and t2 are measured and the re-scaled score is computed with the measured Rougue-L scores. Here, score re-scaling using the Rougue-L score with t1 and the Rougue-L score with t1 is already performed and may be omitted accordingly. That is, a QA pair (t3) having the highest re-scaled score is selected. This process may be iteratively performed until final top-K QA pairs are selected. Here, K denotes a parameter.

[Algorithm 1]
Algorithm 1 Overlapping based reranking

| Given: Passage Psg. | |
|---|---|
| Input: Generated QA pair QA^{gen} = {(qᵢ, aᵢ)}ᵢ₌₁^{N} | |
| Parameter: int k | |
| Define: scoreᵢ ← RankingModule(qᵢ, aᵢ, Psg) | |
| Choose: criterionᵢ ← qᵢ or aᵢ | |
| Choose: Metric ← ROUGE-L or BLEU | |
| 1: | output ← [ ], comparing ← [ ] |
| 2: | while len(output) ≤ k do |
| 3: | for (qⱼ, aⱼ) in QA^{gen} do |
| 4: | if comparing is not EMPTY then |
| 5: | overlapsⱼ = [Metric(criterionⱼ, item) |
| | for item in comparing] |
| 6: | overlapⱼ = max(overlapsⱼ) |
| 7: | Define: scoreⱼ* ← scoreⱼ − overlapⱼ * [scoreⱼ] |
| 8: | else |
| 9: | Define: scoreⱼ* ← scoreⱼ |
| 10: | end if |
| 11: | end for |
| 12: | (qᵢ, aᵢ) ← Pick from QA^{gen} with highest scoreⱼ* |
| 13: | output ← Append (qᵢ, aᵢ) |
| 14: | comparing ← Append criterionᵢ |
| 15: | QA^{gen} ← Pop (qᵢ, aᵢ) |
| 16: | end while |
| 17: | return output |

A detailed process for overlap mitigation is as follows. First, Criterion and Metric are defined. Criterion represents a sentence to be subject to overlap checking among questions or answers and Metric represents an evaluation metric to measure overlap. In main experiments, criterionᵢ is selected as aᵢ (i.e., answer in QA pair) and ROUGE-L is selected as Metric. In this process, Metric returns overlap score between 0 and 1. In estimating overlap, all the sentences are lemmatized and all the stop words are removed in every QA pair.

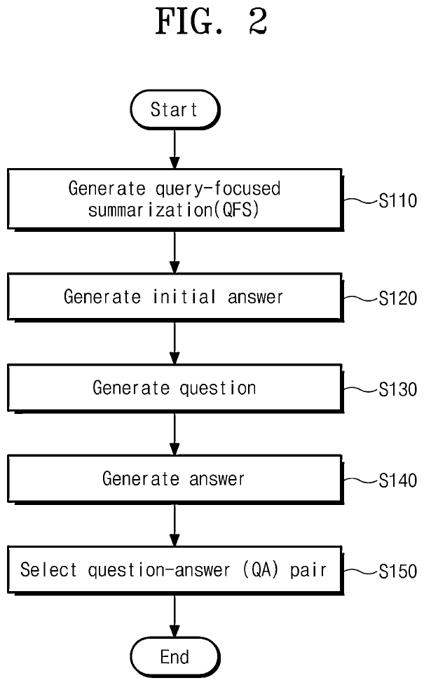

FIG. 2 is a flowchart illustrating a question-answer pair generation method according to an example embodiment of the present invention.

Referring to FIG. 2, the question-answer pair generation method may be performed by a computing device that includes at least one processor and/or a memory. Therefore, at least some of operations included in the question-answer pair generation method may also be referred to as a question-answer pair generation device and may also be understood as an operation of the processor included in the computing device. The computing device may include a personal computer (PC), a server, a laptop computer, a tablet personal computer (PC), and the like. The computing device may be performed through a plurality of devices that are physically separate or may be provided on a cloud. Hereinafter, further description related to repeated contents is omitted in describing the query-answer pair generation method.

Initially, a query-focused summarization (QFS) is generated for a given passage (S110). The number of QFSs corresponding to the number of sentences included in the passage may be generated. That is, a QFS model may receive a passage and a sentence and may output a query-focused summarization (QFS) corresponding to the sentence.

An initial answer is generated based on the passage and the QFS (S120). That is, an answer generator or an answer generation model may receive the passage and the QFS and may output the initial answer corresponding thereto. Since the initial answer corresponds to the QFS, the number of initial answers corresponding to the number of QFSs are generated.

A question corresponding to the initial answer is generated (S130). Since the question is generated to include a predetermined interrogative word, a plurality of (e.g., six) questions may be generated for a single initial answer. That is, a question generator or a question generation model may receive initial answers, passages, and interrogative words, and may output questions corresponding thereto.

Then, an answer corresponding to each generated question is generated (S140). Since the answer corresponds to the question, the number of answers corresponding to the number of questions are generated. That is, a question-answering model receives the question and the passage and outputs the answer corresponding to the question.

A final QA pair is selected from among generated QA pairs (S150). A QA pair selection process is described above and thus, further description is omitted.

Hereinafter, experiments are described in detail.

### Experimental Setup

Dataset: In experiments, FairytaleQA dataset (Xu et al., 2022) is used. FairytaleQA is a dataset that is specifically designed for children's storybook learning and assessment, which corresponds to the purpose of education of the present invention. In a data construction process, educational experts manually created QA pairs to ensure reliability and validity. Training, validation, and test sets contain 8,548 QA pairs from 232 books, 1,025 QA pairs from 23 books, and 1,007 QA pairs from 23 books, respectively. Instead of using narrative elements (e.g., character, setting, action, etc.) presented in the dataset, questions based on interrogative words are diversified to induce expanded types of questions beyond the elements. The existing answer types are used as they are mutually exclusive.

Models: All models constituting the proposed framework are trained with the FairytaleQA dataset. In the case of a query-focused summarization model (QFS model), a summary is generated using model checkpoints provided by Vig et al. (2021). In training AGM, QGM, and QAM, a pretrained BART-large (Lewis et al., 2020) model and framework provided by Fairseq are exploited. For hyperparameters, 2048 max tokens, early stopping 10, and a polynomial decay scheduler are adopted. For a learning rate and dropout, 3e-05 and 0.1 are set in the AGM and the QGM and 2e-05 and 0.2 are set in the QAM. All models are trained on 2 RTX8000 GPUs. RoBERTa-base (Liu et al., 2019) model and Huggingface framework are used for the ranking model. The ranker is trained for five epochs with a fixed learning rate of 5e-07 and a single GPU is used for training.

### Evaluation Metrics

For evaluation metric, the MAP@N score is adopted as a primary metric used by Yao et al. (2022). MAP@N with Rouge-L refers to the averaged value of the maximum score set added by computing Rouge-L between each GT QA pair and top-N generated QA pairs. Each question and answer in the QA pair may be concatenated in this process. However, when MAP@N is measured by the Rouge-L precision score as in Yao et al. (2022), short results are advantageous. This is because this metric measures longest overlap based on the number of candidates. Instead of using precision, the F1 score is selected for accurate measurement. Since metrics based on N-gram overlap do not guarantee quality, BERTScore is additionally adopted for MAP@N to evaluate semantic equivalence based on similarity scores.

### Baselines

Two educational QAG systems are adopted as a baseline.

FQAG: FQAG (Yao et al., 2022) is a state-of-the-art study of FairytaleQA and performs QAG through a three-stage pipeline that includes answer generation question generation, and a ranking module. For re-implementation, provided checkpoints are loaded to generate QA pairs for validation and test sets of FairytaleQA.

SQG: SQG (Dugan et al., 2022) refers to a recently published paper in educational QAG, which utilizes summaries of given passages. QA pairs are generated using answer generation, question generation, and question answering models. In this case, to match the number of top-N, QA pairs are selected based on the generated order. Alternatively, output is increased by adjusting a beam size.

Hereinafter, results and analysis of experiments will be described.

### Automated Evaluation

Result on MAP@N with Rouge-L: Table 1 shows main results of MAP@N with Rouge-L F1 scores according to a QAG system. As a result, the system proposed herein significantly outperforms the baseline model in all splits and top-N outcomes. Especially, in a test set, FQAG is outperformed by +0.068 in the top 10, +0.055 in MAP@5, and +0.048 in MAP@3. SQG achieves better results than FQAG, but still does not outperform the proposed system. Compared to SQG, the proposed system shows improvement in all top-N results mainly from 0.455 to 0.503 (+0.048). The results represent that generating various QA pair candidates and properly establishing plausible pairs serve as one contributing factor to performance improvement.

TABLE 1

| | MAP@N (Rouge-L F1) | | | | MAP@N (BERTScore F1) | | | |
|---|---|---|---|---|---|---|---|---|
| Method | Top 10 | Top 5 | Top 3 | Top 1 | Top 10 | Top 5 | Top 3 | Top 1 |
| FQAG(Yao et | 0.440/0.435 | 0.375/0.374 | 0.333/0.324 | 0.238/0.228 | 0.9077/0.9077 | 0.8990/0.8997 | 0.8929/0.8922 | 0.8768/0.8776 |
| al., 2022) | | | | | | | | |
| SQG(Dugan et | 0.460/0.455 | 0.392/0.388 | 0.344/0.337 | 0.234/0.242 | 0.9056/0.9062 | 0.8953/0.8955 | 0.8876/0.8878 | 0.8707/0.8723 |
| al., 2022) | | | | | | | | |
| Ours | 0.500/0.503 | 0.426/0.429 | 0.369/0.372 | 0.247/0.254 | 0.9156/0.9178 | 0.9046/0.9068 | 0.8956/0.8977 | 0.8752/0.8783 |

Result on MAP@N with BERTScore: MAP@N is measured by employing BERTScore to evaluate semantic equivalence between GT and generated QA pairs. That is, instead of Rouge-L F1 score, an F1 value of BERTScore is used when measuring MAP@N. As a result, the system proposed herein achieves higher performance in all settings except for MAP@1 validation results. In the best case, MAP@10, among test results, FQAG and SQG showed 0.9077 and 0.9062, respectively, and the proposed technique recorded 0.9178, outperforming by +0.0101 and +0.0116. The tendency that performance of the proposed technique is highest is consistent with Rouge-L F1 results. However, it can be observed that FQAG reports higher performance in BERTScore than SQG. Although performance difference is marginal, the results suggest that generated QA pairs of FQAG are semantically better than SQG.

### Statistical Evaluation

To evaluate the question-answer type diversity of generated QA pairs, statistical evaluation is performed. As a result, question types reported in the present invention are more balanced than other models. Unlike other models that usually generate ‘what’ and ‘who’, the proposed QAG system is well balanced with questions of ‘why’ and ‘how’ that require reasoning. This suggests the potential of children to think from various perspectives by being asked different types of questions.

For answer types, the proposed system includes 32.06% of implicit answers, indicating that implicit answers are also well generated, which allows the model to help balance assessments of children. Conversely, other models use an answer span extraction method, resulting in 0% of implicit answers.

### Human Evaluation

For detailed inspection, human evaluation is conducted. For each paragraph, three human evaluators with degree holders or experts in education rate each of three QA pairs generated by GT and three QAG systems. Human evaluation is performed on a total of 20 passages and three QA pairs are sequentially selected for GT and SQG. The following refers to criteria used for human evaluation. For global setting, an evaluator is instructed to rank the entire system and in local cases, to select how many of three QA pairs generated by each system correspond to property items.

(Global setting) Diversity-Q: This ranks generation results of GT and three QAG systems in terms of question diversity. Diversity-A: This ranks generation results of GT and three QAG systems in terms of answer diversity. Quality-E: This ranks the entire system quality from the overall perspective.

(Local setting) Relevancy: This evaluates relevance between a passage and a QA pair. If either a question or an answer is not relevant, it is considered irrelevant. Acceptability: This evaluates whether a question and its corresponding answer are correctly generated. Relevance with the passage is not considered and if either of them is awkward, it is considered incorrect. Usability: This evaluates whether generated QA pairs are available for education purposes. Readability: This evaluates whether the generated QA pairs are grammatically correct. Difficulty: This evaluates whether the generated QA pairs are excessively easy.

Table 2 presents the results of the human evaluation. The approach according to the present invention achieves remarkable performance in terms of question diversity and answer diversity with average ranking of 2.35 and 2.18, respectively. In the global setting, Quality-E is 2.66 in FQAG and 3.30 in SQG, while the proposed system outperforms them with the score of 2.35. The results demonstrate that the proposed QAG is both quantitatively and qualitatively superior in direct comparison with other systems through ranking while enhancing diversity. The results of the local setting represent that the proposed method outperforms both FQAG and SQG except for the readability. As the evaluation results of the generated QA pairs, the relevance of the passages to the generated QA (2.69), the acceptability of the questions to the answers (2.22), and the usability for educational purposes (1.9) show the highest results compared to other systems. Slight performance gain may also be observed over GT in case of difficulty. However, in readability, the results of the proposed method show 2.35, which is lower than 2.64 and 2.55 of the existing models. Since the average length of QA pairs generated with the proposed method is longer, it may cause small tradeoff with difficulty. From the results, it may be concluded that the QA pairs generated with the proposed method are truly effective in ensuring not only quality but also diversity.

TABLE 2

| | global | | | local | | | | |
|---|---|---|---|---|---|---|---|---|
| Method | Diversity-Q ↓ | Diversity-A ↓ | Quality-E↓ | Relevancy ↑ | Acceptability ↑ | Usability ↑ | Readability ↑ | Difficulty↑ |
| FQAG(Yao et al., 2022) | 3.03 | 3.06 | 2.66 | 2.65 | 2.14 | 1.74 | 2.64 | 1.11 |
| SQG(Dagan et al., 2022) | 2.96 | 3.03 | 3.30 | 2.44 | 1.87 | 1.34 | 2.55 | 1.36 |
| Ours | 2.35 | 2.18 | 2.35 | 2.69 | 2.22 | 1.9 | 2.35 | 1.98 |
| GT | 1.65 | 1.71 | 1.68 | 2.97 | 2.65 | 2.50 | 2.80 | 1.95 |

The device described above can be implemented as hardware elements, software elements, and/or a combination of hardware elements and software elements. For example, the device and elements described with reference to the embodiments above can be implemented by using one or more general-purpose computer or designated computer, examples of which include a processor, a controller, an ALU (arithmetic logic unit), a digital signal processor, a microcomputer, an FPGA (field programmable gate array), a PLU (programmable logic unit), a microprocessor, and any other device capable of executing and responding to instructions. A processing device can be used to execute an operating system (OS) and one or more software applications that operate on the said operating system. Also, the processing device can access, store, manipulate, process, and generate data in response to the execution of software. Although there are instances in which the description refers to a single processing device for the sake of easier understanding, it should be obvious to the person having ordinary skill in the relevant field of art that the processing device can include a multiple number of processing elements and/or multiple types of processing elements. In certain examples, a processing device can include a multiple number of processors or a single processor and a controller. Other processing configurations are also possible, such as parallel processors and the like.

The software can include a computer program, code, instructions, or a combination of one or more of the above and can configure a processing device or instruct a processing device in an independent or collective manner. The software and/or data can be tangibly embodied permanently or temporarily as a certain type of machine, component, physical equipment, virtual equipment, computer storage medium or device, or a transmitted signal wave, to be interpreted by a processing device or to provide instructions or data to a processing device. The software can be distributed over a computer system that is connected via a network, to be stored or executed in a distributed manner. The software and data can be stored in one or more computer-readable recorded medium.

A method according to an embodiment of the invention can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc., specially designed to store and execute program instructions. Examples of the program instructions may include not only machine language codes produced by a compiler but also high-level language codes that can be executed by a computer through the use of an interpreter, etc. The hardware mentioned above can be made to operate as one or more software modules that perform the actions of the embodiments of the invention and vice versa.

Although the present invention is described with reference to the example embodiments illustrated in the drawings, it is provided as an example only and it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents. Therefore, other implementations, other example embodiments, and equivalents are within the scope of the following claims.

What is claimed is:

1. A method for question-answer pair generation performed by a computing device, the method comprising:
generating a query-focused summarization (QFS) for a passage;
generating an initial answer based on the passage and the QFS;
generating a question corresponding to the initial answer based on the initial answer, the passage, and an interrogative word;
generating an answer corresponding to the question based on the question and the passage and generating a question-answer (QA) pair; and
deriving a final QA pair by selecting at least one QA pair from among the QA pairs.

2. The method of claim 1, wherein the generating of the QFS comprises generating the number of QFSs corresponding to the number of sentences included in the passage.

3. The method of claim 1, wherein the generating of the initial answer comprises receiving a passage and a QFS, inputting the passage and the QFS into an answer generation model pretrained to generate an initial answer, and generating the initial answer.

4. The method of claim 1, wherein the generating of the question comprises receiving an initial answer, a passage, and an interrogative word, inputting the initial answer, the passage, and the interrogative word into a question generation model pretrained to generate a question, and generating the question, and
the interrogative word includes what, why, when, who, where, and how.

5. The method of claim 1, wherein the generating of the QA pair comprises receiving a question and a passage, inputting the question and the passage into a question-answering model pretrained to generate an answer, and generating the answer.

6. The method of claim 1, wherein the deriving of the final QA pair comprises:
deriving the ranking score of the QA pair; and
selecting a QA pair with the highest ranking score.

7. The method of claim 6, wherein the deriving of the ranking score comprises inputting the QA pair into a ranking model pretrained to perform binary classification regarding whether an input QA pair is a correct example or an incorrect example and deriving the ranking score.

8. The method of claim 7, wherein the deriving of the ranking score represents a probability that the QA pair is classified as the correct example.

9. The method of claim 6, wherein the deriving of the ranking score comprises:
measuring the Rouge-L score between the QA pair with the highest ranking score and remaining QA pairs;
deriving the adjusted ranking score of each QA pair by subtracting the product between the Rouge-L score and an absolute value of the ranking score from the ranking score; and
selecting a QA pair with the highest adjusted ranking score.
